(19) United States
(12) Patent Application Publication
(10) Pub. No.: US 2014/0054985 A1
(43) Pub. Date: Feb. 27, 2014

(54) INTERNALLY EXICTED SYNCHRONOUS MOTOR COMPRISING A PERMANENT MAGNET ROTOR WITH MULTIPLE CORROSION PROTECTION

(71) Applicant: Johann Neiszer, Schwabisch Gmund (DE)

(72) Inventor: Johann Neiszer, Schwabisch Gmund (DE)

(73) Assignee: ANDRITZ RITZ GMBH, Schwabisch Gmund (DE)

(21) Appl. No.: 14/001,461

(22) PCT Filed: Feb. 24, 2011
(86) PCT No.: PCT/EP11/00911

§ 371 Date: Nov. 14, 2013

(51) Int. Cl. H02K 5/132

(52) U.S. Cl. CPC H02K 5/132
USPC 310/43; 310/87; 310/45

(57) ABSTRACT

A module for a rotor of an electric machine, said rotor being excited by means of permanent magnets and rotating in a liquid medium, wherein the module contains a cylindrical, active part having a plurality of circular, magnetically soft laminations which form a laminated stack and have a central opening for receiving a rotor shaft; wherein at least two permanent magnets protected against the liquid medium are arranged in at least two corresponding cutouts in the laminated stack, the cutouts being formed under a cylindrical circumferential surface of the laminated stack.

### CROSS-REFERENCE TO RELATED APPLICATION

This application is the National Stage of International Application No. PCT/EP2011/000911, filed Feb. 24, 2011, which is hereby incorporated by reference.

### FIELD OF THE INVENTION

The present invention relates to electric machines excited by means of permanent magnets. The invention relates more particularly to a rotor of an electric machine, which rotates in a liquid medium and in which the permanent magnets are embedded (internally excited electric machine).

### TECHNICAL BACKGROUND

In the field of electric drives, it is necessary or expedient in some applications that the rotor of a three-phase machine is not located in a gas-filled space, but in a space filled with a liquid. Such rotors and the electric machines formed by them are also referred to as “glandless”. Depending on the requirements of a specific application, the rotor can run in many conceivable liquid media, for example in drinking water, in brine or in other aggressive liquids. To that end, the rotor and its components must be protected against adverse effects of the liquid medium, such as corrosion, in order to provide a high level of reliability and a long service life for the electric machine.

The concept of glandless machines has advantages for thermal management (cooling), for example. A liquid coolant, such as water, can remove the heat produced during operation better than a gas. This makes it easier to prevent heat accumulation and damage to rotor components. With such designs, it is also possible to counteract any overheating of the magnets, i.e. potential demagnetisation of the magnets.

The concept of glandless machines has constructional advantages as well. For example, sealing a machine casing in environments involving high external pressures is made simpler, in that the entire interior of the electric machine is substantially filled with a liquid that is incompressible relative to gases. In deep-sea applications, the design pressure may be 1000 bar, for example, whereas the internal pressure of gas-filled electric machines is in the order of 1 bar. Such high pressure differences are almost impossible to withstand using gland seals or other sealing means. By filling the rotor compartment of an electric machine with a liquid, it is also possible to dispense with an additional seal between the stator and rotor of the machine, for example in the form of a can, when the same liquid medium is present throughout the machine. This not only simplifies the design of the machine, but also helps to improve the electrical and mechanical characteristics of the machine. For example, a smaller magnetic path between the rotor and stator may be selected, which is advantageous for torque and efficiency (increase in gap induction). The liquid medium in the rotor compartment can also be guided in a single cooling circuit through the entire electric machine and simultaneously serve as a lubricant for the slide bearings of the rotor shaft.

Three-phase permanent-magnet machines have advantages over other kinds of three-phase machine (e.g. asynchronous machines, electrically excited synchronous machines and reluctance machines) inter alia in respect of design complexity, reliability, efficiency, torque and power factor. In the case of three-phase permanent-magnet machines, it is also normal, due to problems keeping them securely fastened at high rotor speeds, to not fix the magnets to the circumferential surface of the rotor, but in cutouts inside a magnetically active rotor portion. The permanent magnets are generally made of materials that are likewise prone to corrosion. It is therefore considered difficult and complicated to manufacture glandless, permanent-magnet pumps that have a high level of reliability and a long service life.

DE 10 2007 028 356 A1 shows an electric motor comprising a rotor module forming an active rotor portion. Permanent magnets are integrated in the active rotor portion or rotor module in such a way that they are protected against chemical attack. The active rotor portion and a shaft connected thereto are made of a corrosion-resistant stainless steel and are preferably integral in design. According to DE 10 2007 028 356 A1, using modules in the form of stacked laminations, such as those known from EP 1 657 800 A1, is not an option. Since it is not possible to provide a secure seal between such single, stacked laminations, it is also not possible to protect the permanent magnets against corrosive media. The cited patent application states, with regard to sealing and secure embedding of the magnets in the rotor modules, that the rotor modules are joined by positive engagement and the joining lines are sealed form-fittingly and in a material fit. The pockets for receiving the magnets are sealed by separate means. The join between the sealing means and the active rotor portion is preferably formed by weld connections.

In applications involving very high pressure loads, e.g. deep-sea applications, durability and long service life are required for plant deployed in deep waters. In this field of application, it is too complicated and expensive to bring the plant frequently to the surface in order to service it or replace it. Given that very high operating pressures prevail both outside and inside the casing of electric machines in high-pressure applications, it is particularly difficult to provide secure sealing of a glandless pump rotor and its corrosion-sensitive components against the surrounding liquid medium.

An object of the present invention is to provide a cost-efficient and more easily manufactured permanent magnet for electric machines, which is floatingly arranged in a liquid medium and permits long lifetimes and high levels of reliability.

This object is achieved with a permanent-magnet rotor module according to claim 1. The dependent claims relate to further advantageous embodiments of the invention.

### OVERVIEW OF THE INVENTION

The invention provides a module for a rotor of an electric machine, said (glandless pump) rotor being excited by means of permanent magnets and rotating in a liquid medium.

In a first embodiment, the module according to the invention contains a cylindrical, active part having a plurality of circular, magnetically soft laminations which form a laminated stack and have a central opening for receiving a rotor shaft, wherein at least two permanent magnets protected against the liquid medium are arranged in at least two matching cutouts in the laminated stack, the cutouts being formed beneath a cylindrical circumferential surface of the laminated stack.

In the module, the permanent magnets may be coated on all sides with a protective lacquer film. The lacquer film is a first protective barrier for protecting the corrosion-sensitive permanent magnets against the liquid medium.

In the module, the laminations may each have a substantially continuous adhesive film on at least one side and be baked together to form the laminated stack. This continuous adhesive film is a second protective barrier for the corrosion-sensitive permanent magnets and the corrosion-sensitive laminations.

In the module, the inner surfaces of the cutouts in the laminated stack may be provided with a substantially continuous plastic coating. This coating of the inner surfaces is a third protective barrier for protecting the corrosion-sensitive permanent magnets and the corrosion-sensitive laminations.

In the module, the spaces between the permanent magnets and the inner surfaces of the cutouts in the laminated stack may be substantially filled with a plastic filling. This plastic filling is a fourth protective barrier for protecting the corrosion-sensitive permanent magnets.

In the module, the permanent magnets may be somewhat smaller in size in the axial direction of the module than the axial length of the module, the permanent magnets being arranged in the axial direction of the module in the middle of the cutouts in such a way that they are spaced apart from the two end faces of the module, and the respective spaces between the permanent magnets and the end faces of the module being substantially filled with a plastic filling. This plastic filling is a fifth protective barrier for protecting the corrosion-sensitive permanent magnets.

The entire module may be provided with a protective lacquer coating. This protective lacquer is a sixth protective barrier for protecting the corrosion-sensitive permanent magnets and the corrosion-sensitive laminations.

In the module, flux barriers in the form of further cutouts in the laminated stack may be provided in addition to the at least two cutouts for the permanent magnets, said additional cutouts being substantially filled with a plastic material. This prevents the liquid medium from accumulating in cutouts inside the rotor.

According to another aspect of the present invention, a rotor of an electric machine excited by means of permanent magnets is provided, said rotor having a rotor shaft and at least one modular unit, wherein each of the at least one modular units comprises at least one module according to the invention and fitted to the rotor shaft.

In each of the at least one modular units in the rotor, a plurality of the modules may be glued together over substantially their entire end faces by means of an adhesive film. This adhesive film is a seventh protective barrier for the corrosion-sensitive permanent magnets and the corrosion-sensitive laminations.

In the rotor, each of the at least one modular units may be entirely encased in a protective lacquer coating. This coating is an eighth protective barrier for protecting the corrosion-sensitive permanent magnets and the corrosion-sensitive laminations.

In the rotor, each of the at least one complete modular units may be encapsulated in a sleeve consisting of a corrosion-resistant material. This sleeve is a ninth protective barrier for protecting the corrosion-sensitive permanent magnets and the corrosion-sensitive laminations.

In the rotor, the rotor shaft and the sleeve may be made of stainless steel, the sleeve having a circumferential section extending around the outer circumference of the modular unit and two end sections arranged at the opposite ends of the modular unit, and each of said end sections being welded at its radially inner edges to the rotor shaft.

In the rotor, a plurality of modular units may be arranged on the rotor shaft. This means that the performance of an electric machine formed with this rotor can be easily scaled.

According to another aspect of the present invention, an electric machine is provided which includes the rotor according to the invention. Such a machine is an internally excited, permanent-magnet glandless machine having a cost-efficient rotor composed of laminations.

According to another aspect of the present invention, a pump is provided which has an electric machine according to the invention as its drive motor. Such a pump can be manufactured more cost-efficiently and also has a high level of reliability and long service life, even under tough conditions such as extremely high external pressures.

One advantage of the permanent magnet rotor module according to the present invention is that the rotor can be assembled from inexpensive and easily machined laminations, without complicated machining, for example, being required to manufacture an integral rotor. Due to the magnets being arranged inside the rotor module and the laminations and the permanent magnets being reliably protected against the liquid medium, such as water, very long lifetimes and a high level of reliability can be achieved for a glandless pump rotor of such construction. By preventing the liquid medium from penetrating the rotor module, because the interior of the module cannot be reached by the medium and also because there are basically no cutouts inside the module, balancing problems are also prevented that might ensue when, after balancing the rotor in operation, a liquid medium seeps into such cutouts or amounts of fluid contained therein before the balancing operation are flung out by centrifugal forces at high rotational speed, thus causing the mass distribution of the rotor to be altered. Due to the modular design of a glandless pump rotor according to the invention, an electric machine can be scaled to almost overall length and hence power that may be desired. Standardised rotor modules may be used for that purpose, thus simplifying production and making it more cost-efficient.

### BRIEF DESCRIPTION OF THE DRAWINGS

FIG. 1 shows a perspective view of a laminated stack of the rotor module according to the present invention.

FIG. 2 shows a plan view of a rotor module according to the present invention, with permanent magnets inserted therein.

FIG. 3 is an enlarged section of the rotor module of FIG. 2 and shows a permanent magnet inserted into the module and the arrangement of lacquer and plastic films in more detail.

FIG. 4 is a cross-sectional view showing a longitudinal section through a rotor module according to the present invention.

FIG. 5 shows a side view of a rotor according to the present invention.

FIG. 6 shows a plan view of a single lamination of a further embodiment of the module according to the present invention.

FIG. 7 shows a longitudinal sectional view of a further embodiment of a rotor according to the present invention.

### PRECISE DESCRIPTION OF ADVANTAGEOUS EMBODIMENTS OF THE INVENTION

Advantageous embodiments of the present invention shall now be described in greater detail.

In a first embodiment, a module 10 for a rotor of an electric machine comprises a cylindrical, active part, said rotor being excited by means of permanent magnets and rotating in a liquid medium. Said active part is composed of a magnetically soft laminated stack 20 having permanent magnets 200 embedded therein.

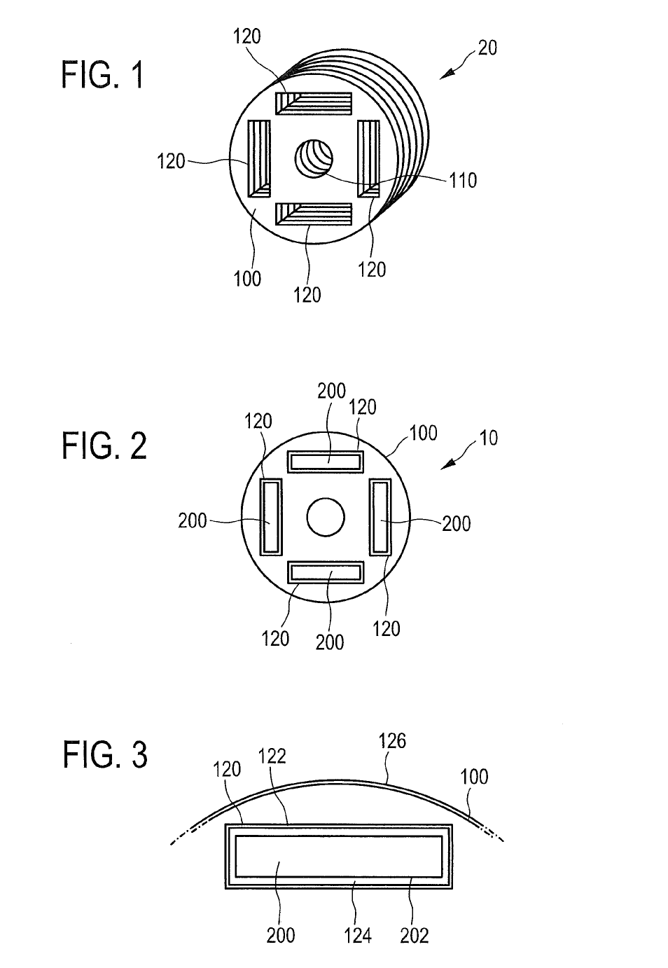

As is shown in FIG. 1, the laminated stack 20 of rotor module 10 according to the present invention comprises a stack consisting of a plurality of plates or laminations 100 made of a magnetically soft material, such as commercially available laminations in the form of transformer or dynamo laminations. These identical laminations 100 preferably have a circular outer edge and at their centre a substantially circular opening 110, coaxial with the circular outer edge, for receiving a rotor shaft 30. For torque transmission between the active rotor part or rotor module 10 formed by laminated stack 20 and the rotor shaft 30 guided through opening 110, opening 110 may have a non-circular shape, for example a flattening of the circle on one side, or a bulge projecting from lamination 100 towards the centre and engaging with a complementary shape (flattened portion or groove) on rotor shaft 30, of the kind that is familiar to a person skilled in the art and not shown in the Figures.

A plurality of identical laminations, usually about 0.5 mm thick, for example, are stacked with identical orientation in such a way that central opening 110 and cutouts 120 are aligned, thus forming passageways running in a straight line in the axial direction through laminated stack 20. The number of laminations 100 depends on the desired axial length and hence on the performance of the rotor module 10 thus formed. A typical module 10 has an axial length L of about 30 mm auf and contains about 60 stacked laminations. Before being joined together, the single laminations 100 are coated substantially continuously on one or both sides with an insulating adhesive, so that they bake together in a baking operation and form a solid unit in the form of laminated stack 20. This adhesive coating 102 may be applied prior to assembly, for example by spraying, brushing or dipping, or it may already be applied to ready-made laminations. As a skilled person will be aware, the adhesive can be activated by heat and/or pressure. This substantially continuous adhesive film 102 helps to protect the laminations 100 and the permanent magnets 200 embedded in laminated stack 20 against an aggressive liquid medium.

As shown in FIG. 2, laminations 100 also have a number of cutouts 120 for receiving permanent magnets 200, said number corresponding to the number of poles of rotor module 10. At least two poles or one pair of poles, and hence two cutouts 120, are normal, but four poles and hence four such cutouts 120 arranged at 90° to each other are preferably provided. In the Figures, embodiments with four poles (two pairs of poles) are shown in rotationally symmetric arrangement. However, more than two pairs of poles and thus more than four cutouts 120 are also possible. Cavities 120 are arranged within and at a particular distance from the circular outer edge of laminations 100 and have respectively defined extensions in the radial direction and in the circumferential direction, such that sufficiently strong webs remain between cutouts 120 for absorbing the centrifugal forces arising during operation and for ensuring suitable magnetic characteristics. The magnetic characteristics of the webs remaining between cutouts 120 affect the performance of the electric machine and also its electrical characteristics.

Cavities 120 are preferably rectangular, as shown in the Figures, because it is then possible to insert easily and cost-efficiently produced permanent magnets 200 of rectangular shape. However, other shapes for the cutouts and for the matching magnets are possible, such as arcuate sections or trapezoidal shapes. Cavities 120 are preferably adapted to the outer dimensions and shape of the permanent magnets such that only small interspaces ensue between the magnets and laminated stack 20 and a strong magnetic flux can be achieved, which is important for a high torque and high efficiency of the electric machine.

The rectangular cutouts 120 and permanent magnets 200 are shown in the Figures in such a way that their longer longitudinal dimensions extend substantially in the circumferential direction of the rotor module and their shorter dimensions extend in the radial direction. They are magnetised in the radial direction, i.e. the magnetic poles are radially on the outside and inside of the permanent magnets. Other orientations of cutouts 120 and permanent magnets 200 are possible, however, for example with their longitudinal extension being oriented substantially radially, or at an angle to a radius. The direction of magnetisation may also deviate from the case described above. Different electrical and operating characteristics of the rotor and the electric machine formed by it can therefore be obtained, as a skilled person will be aware.

In one advantageous variant of the rotor module, as shown in greater detail in FIG. 3, permanent magnets 200 are coated on all sides, i.e. completely, with a thin protective lacquer film 202 that protects the corrodible material of permanent magnets 200 against the liquid medium.

In another advantageous embodiment of the invention, the inner surfaces of the cutouts 120 in the laminated stack 20 may be provided with a substantially continuous plastic coating 122 consisting, for example, of an epoxy resin. This coating 122 on the entire inner surface of cutouts 120 is carried out before permanent magnets 200 are inserted into cutouts 210. Continuous coating 122 and the protective lacquer film 202 on all sides of the permanent magnets 200 prevents scraping between the hard material of permanent magnets 200 and the laminations when the magnets 200 are inserted into the cutouts 120 provided, thus ensuring that neither the thin protective lacquer film 202 not continuous coating 122 are damaged on insertion of magnets 200 into laminated stack 20. The protective function of the protective lacquer film and of the continuous plastic coating 122 can thus be ensured, in order to prevent any corrosion of laminations 100 or the permanent magnets by the liquid medium.

The interspaces between permanent magnets 200 and laminated stack 20, which are still open after insertion of magnets 200, can then be completely filled with a plastic material, for example an epoxy resin. In another advantageous embodiment of the invention, the rotor module has a plastic filling 124 that substantially fills the spaces between permanent magnets 200 and the inner surfaces of cutouts 120. Plastic filling 124 may consist of the same plastic material as the continuous coating 122, or may be made of a different plastic material.

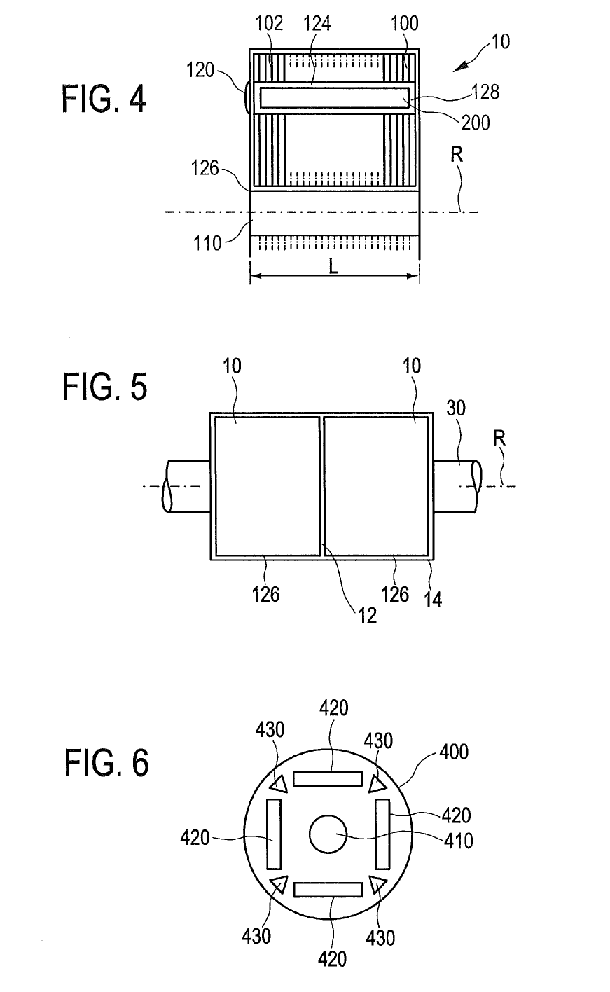

In yet another advantageous embodiment of the invention, and as shown in FIG. 4, permanent magnets 200 are somewhat smaller in size in the axial direction of the module than the axial length L of the module or the laminated stack. Permanent magnets 200 are arranged in the axial direction of the module in the middle of cutouts 120 in such a way that they are spaced apart from the two end faces of the module. The dimensions of magnets 200 are selected such that, at the two end faces, a gap of a few tenths of a millimetre is produced between magnets 200 and the end faces, preferably a gap of approximately 0.2-0.3 mm. The empty space thus formed at the respective end face is substantially filled with a plastic filling 128. Plastic filling 128 may consist of the same plastic material as the continuous coating 122 or plastic filling 124, or it may be made of a different plastic material. This prevents permanent magnets 200, consisting of a hard and brittle material, from touching and damaging each other when assembling a plurality of rotor modules 10, and also ensures that a reliable seal is provided at the end faces of modules 10 and that the liquid medium cannot penetrate as far as laminations 100 or permanent magnets 200.

As can also be seen in FIGS. 3 and 4, the completely assembled rotor module 10 is completely covered, in another advantageous embodiment of the invention, with a protective lacquer coating 126. This outer protective lacquer coating 126 forms a further barrier against penetration of the liquid medium as far as laminations 100 and the permanent magnets 200 embedded therein, in order to achieve a long service life and a high level of reliability for an electric machine comprising a rotor module according to the invention.

FIG. 5 shows an advantageous embodiment of a rotor according to the present invention. The rotor rotating in a liquid medium comprises a rotor shaft 30, which is preferably made of corrosion-resistant stainless steel, and at least one modular unit fitted onto rotor shaft 30 coaxially with the rotational axis R of rotor shaft 30. Each modular unit comprises at least one rotor module 10 according to the invention and fitted to rotor shaft 30. FIG. 5 shows a rotor which comprises a modular unit having two modules 10. As is obvious to a person skilled in the art, the rotor may also have just one rotor module 10, or it may include almost any desired number of modular units with almost any desired number of modules 10. The modular units may be spaced apart from each other in the axial direction. The number and arrangement of the modular units and the number of modules in each modular unit is based on the specific application and the associated requirements in respect of performance, operating characteristics and geometrical construction of the electric machine that is needed. Due to this modular construction of the active part of the rotor, it is possible to scale the performance of the electric machine in a simple manner using standardised components.

In another advantageous embodiment of the invention, the rotor modules 10 grouped together in a modular unit are glued together over substantially their entire end faces by means of an adhesive film 12. The liquid medium is thus prevented by a further barrier from penetrating between rotor modules 10 to the end faces of rotor modules 10.

Finally, a completely assembled modular unit may be provided with an additional protective lacquer sheath 14 forming a further barrier against the liquid medium penetrating in the direction of laminations 100 and permanent magnets 200.

In yet another embodiment of the invention, and as shown in FIG. 6, further cutouts 430 serving as flux barriers may be provided between the cutouts 420 in the laminations 400 of a rotor module 10 that are used to receive permanent magnets 200. These flux barriers 430 give the rotor module different reluctance values in the circumferential direction, thus giving reluctance motor characteristics to the electric machine formed in this manner. In this way, a hybrid synchronous machine is obtained, which provides certain benefits for certain applications in comparison with a synchronous machine, for example better operating behaviour in the field-weakening area, a lower blocking moment in the event of a short circuit in the circuit, and similar benefits of which a person skilled in the art will be aware.

These flux barriers 430 in the form of further cutouts 430 in laminations 400 may be circular in shape or can have some other shape. Requirements regarding the webs remaining between cutouts 420 and cutouts 430 and concerning the absorption of centrifugal forces need to be taken into consideration here as well. By reducing the size of permanent magnets 200 and hence of cutouts 420 in the circumferential direction of rotor module 10 and by increasing the size of the flux barriers, it is possible to vary the characteristics and operating behaviour of a resultant electric machine between those of a synchronous machine and those of a reluctance machine (reluctance motor).

The cutouts 430 in the laminated stack 20 of a rotor module 10 may be substantially filled with a plastic material, for example an epoxy resin, such that there are no cavities in which the liquid medium might accumulate. This embodiment also ensures, therefore, that once a rotor has been balanced, such balancing is not disturbed again by migration of liquid inside a rotor module. Completely filling cutouts 430 in this way also helps, with regard to high-pressure applications involving pressures in the order of several hundred bar, to seal the entire rotor module reliably and hence to protect the permanent magnets and the laminations against the liquid medium, so that the electric machine has a long lifetime or service life and achieves a high level of reliability.

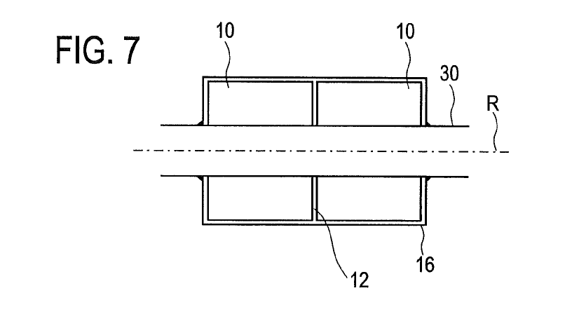

In another embodiment of the present invention, and as shown in FIG. 7, the rotor comprises at least one modular unit containing at least one module 10, wherein each complete modular unit is encapsulated in a sleeve 16 made of a corrosion-resistant material. Sleeve 16 may be made of stainless steel and consist of a circumferential section extending around the outer circumference of the modular unit, and two end sections arranged at the opposite ends of the modular unit, which may, for example, be thin plates suitably shaped and welded together. The circumferential section is preferably as thin as possible, for example with a thickness of about 0.2-0.3 mm, so that the active magnetic gap between the rotor and the stator is not excessively enlarged and eddy-current losses can be minimised. The end sections are welded at their radially inner edges to the rotor shaft 30 likewise made of stainless steel, thus resulting in hermetically sealed encapsulation of the modular unit by means of the corrosion-resistant material of sleeve 16.

Due to some or several of the features described above being provided, such as protective lacquer films and plastic fillings, it is possible to ensure with a high level of reliability over a very long lifetime of an electric machine that the liquid medium cannot penetrate as far as laminations 100 or permanent magnets 200 and damage them, for example by corroding them. This is particularly relevant in deep-sea applications, for example, where maintenance or repair or replacement of an electric machine is a protracted and cost-intensive matter. Preventing the liquid medium from penetrating inside the rotor according to the invention also ensures that, once the rotor has been balanced during operation, such balancing is not rendered void by the migration of liquid medium inside the rotor.

According to another aspect of the invention, an electric machine is provided that has a rotor according to the embodiments described above. This electric machine may be a synchronous machine excited by permanent magnets, or a hybrid synchronous machine whose rotor rotates directly in a liquid medium. The protection given to the rotor module 10 or the rotor according to the present invention ensures that the laminations 100, 400 of rotor module 10, and the permanent magnets 200 embedded therein, are not attacked by an aggressive liquid medium, and hence that a long lifetime and a high level of reliability can be achieved for the electric machine.

According to yet another aspect of the invention, a pump containing an electric machine according to the invention as its drive motor is provided. Such a pump can therefore have a long service life and a high life expectancy, while also being highly reliable.

Other advantages of the invention include, for example, that a synchronous machine or hybrid synchronous machine can achieve a higher torque, compared to a reluctance motor or an asynchronous machine, owing to the possible use of inexpensive glandless permanent magnet pumps, thus leading, for example, to smaller motor diameters while keeping the same performance and length of the motor. When applied to the high-pressure casings required in deep-sea applications, which have to withstand a design pressure of 1000 bar, using the rotor module of the present invention results in significant savings in size, especially in the diameter. In the case of such cylindrical high-pressure casings, the costs increase much more steeply with increasing diameter than with increasing length.

The electric machine according to this invention can also be designed as a canned rotor machine, in which the rotor compartment is separated fluid-tightly from the stator compartment by a can disposed in an induction gap (air gap), in order, for example, to use different fluids for rotor cooling and lubrication, on the one hand, and for stator cooling, on the other hand. The can may also be used to form two separate circuits with the same fluid.

In addition to the advantage of greater efficiency obtained by using internally excited, permanent-magnet synchronous or hybrid synchronous machines as glandless pumps, compared to reluctance machines or asynchronous machines, further advantages consist, for example, in a very high planimetric efficiency, increased power of the motor (or generator), a reduction in motor current and hence smaller cable cross-sections, a constant rotor speed over the entire load range, lower specific heat, savings on rotor bars and short-circuit rings (so no soldering required in that respect during production), and reductions in weight and length of an electric machine for a predefined rating.

### LIST OF REFERENCES SIGNS

(10) Rotor module
(12) Adhesive film
(14) Protective lacquer sheath
(16) Sleeve
(20) Laminated stack
(30) Rotor shaft
(100), (400) Lamination
(110), (410) Central opening
(120), (420) Cavity
(121) Adhesive film
(122) Plastic coating
(124) Plastic filling
(126) Protective lacquer coating
(128) Plastic filling
(200) Permanent magnet
(202) Protective lacquer coating
(430) Flux barriers

What is claimed is:

1. A module for a rotor of an electric machine, said rotor being excited by means of permanent magnets and rotating in a liquid medium, the module comprising:
a cylindrical, active part having a plurality of circular, magnetically soft laminations which form a laminated stack and have a central opening for receiving a rotor shaft; and
at least two permanent magnets protected against the liquid medium are arranged in at least two matching cutouts in the laminated stack, the cutouts being formed beneath a cylindrical circumferential surface of the laminated stack.

2. The module according to claim 1, wherein
the permanent magnets are coated on all sides with a protective lacquer film.

3. The module according to claim 1, wherein
the laminations each have a substantially continuous adhesive film on at least one side and are baked together to form the laminated stack.

4. The module according to claim 1, wherein
the inner surfaces of the cutouts in the laminated stack are provided with a substantially continuous plastic coating.

5. The module according to claim 1, wherein
the spaces between the permanent magnets and the inner surfaces of the cutouts in the laminated stack are substantially filled with a plastic filling film.

6. The module according to claim 1, wherein
the permanent magnets are somewhat smaller in size in the axial direction of the module than the axial length of the module;
wherein the permanent magnets are arranged in the axial direction of the module in the middle of the cutouts in such a way that they are spaced apart from the two end faces of the module; and
wherein the respective spaces between the permanent magnets and the two end faces of the module are substantially filled with a plastic filling.

7. The module according to claim 1, wherein
the entire module is provided with a protective lacquer coating.

8. The module according to claim 1,
wherein
flux barriers in the form of further cutouts in the laminated stack are provided in addition to the at least two cutouts for the permanent magnets, wherein said additional cutouts are substantially filled with a plastic material.

9. A rotor of an electric machine excited by means of permanent magnets, said rotor being excited by means of permanent magnets and rotating in a liquid medium, said rotor having a rotor shaft and at least one modular unit, wherein each of the at least one modular units comprises at least one module fitted to said rotor shaft
each of the at least one modular units comprising,
a cylindrical, active part comprising a plurality of circular, magnetically soft laminations which form a laminated stack and have a central opening for receiving a rotor shaft; and
at least two permanent magnets protected against the liquid medium are arranged in at least two matching cutouts in the laminated stack, the cutouts being formed beneath a cylindrical circumferential surface of the laminated stack.

10. The rotor according to claim 9,
where
in each of the at least one modular units a plurality of the modules are glued together over substantially their entire end faces by means of an adhesive film.

11. The rotor according to claim 10, wherein
each of the at least one modular units is entirely encased in a protective lacquer sheath.

12. The rotor according to claim 9, wherein
each of the at least one complete modular units is encapsulated in a sleeve consisting of a corrosion-resistant material.

13. The rotor according to claim 12, wherein
the rotor shaft and the sleeve are made of stainless steel; and
the sleeve has a circumferential section extending around the outer circumference of the modular unit and two end sections arranged at the opposite ends of the modular unit,
each of said end sections being welded at its radially inner edges to the rotor shaft.

14. An electric machine comprising a rotor excited by means of permanent magnets, said rotor being excited by means of permanent magnets and rotating in a liquid medium, said rotor comprising a rotor shaft and at least one modular unit, wherein each of the at least one modular units comprises at least one module fitted to said rotor shaft, each of the at least one modular units comprising,
a cylindrical, active part comprising a plurality of circular, magnetically soft laminations which form a laminated stack and have a central opening for receiving a rotor shaft; and
at least two permanent magnets protected against the liquid medium are arranged in at least two matching cutouts in the laminated stack, the cutouts being formed beneath a cylindrical circumferential surface of the laminated stack.

15. The electric machine of claim 14, wherein said electric machine is the drive motor of a pump.
